(19) United States
(12) Patent Application Publication
(10) Pub. No.: US 2006/0146560 A1
(43) Pub. Date: Jul. 6, 2006

(54) Structured light projector

(75) Inventors: Andrew C. Lewin, Worcestershire (GB); David A. Orchard, Worcestershire (GB)

Correspondence Address: NIXON & VANDERHYE, PC, 901 NORTH GLEBE ROAD, 11TH FLOOR, ARLINGTON, VA, 22203, US

(73) Assignee: QINETIQ LIMITED, London (GB)

(21) Appl. No.: 10/534,495

(22) PCT Filed: Nov. 11, 2003
(86) PCT No.: PCT/GB03/04858

§ 371 Date: May 10, 2005

(30) Foreign Application Priority Data
Nov. 11, 2002 (GB) 0226241.8

(51) Int. Cl. G01D 11/28

(52) U.S. Cl. 362/560

(57) ABSTRACT

This invention relates to an illumination means for illuminating a scene with a two dimensional pattern of intensity, such as an array of distinct spots or array of lines. A light source (4) such as an LED is arranged to illuminate the input face of a light guide (6), either directly or through a mask. The light guide comprises a solid or hollow tube, generally of a constant, regular cross section which is arranged to create multiple images of the light source. Projection optics (8) is arranged to project the array towards the scene with a larger depth of field than conventional techniques.

This invention relates to a structured light generator for illuminating a scene such as might be used with a range finding apparatus such as an imaging range finding system.

Imaging range finding systems often illuminate a scene and image the light reflected from the scene to determine range information.

One known system, a so called triangulation system, uses a source arranged to illuminate a scene with a beam of light such that a spot appears in the scene. A detector is oriented in a predetermined fashion with respect to the source such that the position of the spot of light in the scene reveals range information. The beam of light may be scanned in both azimuth and elevation across the scene to generate range information from across the whole scene. In some systems the beam of light may be a linear beam such that one dimensional range information is gathered simultaneously and the linear beam scanned in a perpendicular direction to gain range information in the other dimension.

Illumination systems of this sort often use laser systems. Laser systems may have safety implications and require complicated and relatively expensive scanning mechanisms. Lasers are also relatively high power sources.

Another type of illumination system is described in U.S. Pat. No. 6,377,353. Here a structured light generator is described which comprises a light source arranged in front of a patterned slide which has an array of apertures therein. Light from the sources only passes through the apertures and projects an array of spots onto the scene. The range information in this apparatus is determined by analysing the size and shape of the spots formed.

This type of illumination system blocks a proportion of the light generated by the source however and as such requires a relatively high power source to generate the illumination required. Further the depth of field of the illuminations system is somewhat limited and discrimination is difficult at low ranges.

U.S. Pat. No. 4,294,544 discloses a topographic measurement system for defining a remote surface which has an illuminator for illuminating the scene with an array of laser beams which are sequenced in a particular manner. The projection means described is a complicated system of shearing plates and beam steering means. The device produces a collimated array of light beams which may not be suitable for all applications and uses a high powered laser source.

It is therefore an object of the invention to provide a structured light source that mitigates at least some of the above mentioned disadvantages. As used in this specification the term structured light generator shall be taken to mean a source which projects a plurality of distinct areas of light towards a scene.

Therefore, according to the present invention there is provided a structured light generator for illuminating a scene comprising a light source arranged to illuminate part of the input face of a light guide, the light guide comprising a tube having substantially reflective sides and being arranged together with projection optics so as to project an array of images of the light source towards the scene.

The light guide in effect operates as a kaleidoscope. Light from the source is reflected from the sides of the tube and can undergo a number of reflection paths within the tube. The result is that multiple images of the light source are produced and projected onto the scene. Thus the scene is illuminated with an array of images of the light source. Where the source is a simple light emitting diode the scene is therefore illuminated with an array of spots of light. The structured light generator of the present invention is advantageous in that it offers a large depth of field. The depth of field of the generator will obviously determine the range over which the generator can be effectively used and a large depth of field means that the device has a larger effective range of operation. This is especially useful when used as an illumination source in ranging applications as it allows the same apparatus to be used to determine range to relatively nearby objects as well as distant objects. It also allows operation in a scene having a large possible variation of range in the scene. Furthermore the image replication occurring within the light guide means that images of the light source are projected evenly across a very wide angle. In other words the array of spots projected onto the scene is not limited in angle as some prior art devices are which again is very useful in ranging applications where a wide field of view to relatively distant objects may be required.

The light guide comprises a tube with substantially reflective walls. Preferably the tube has a constant cross section which is conveniently a regular polygon. Having a regular cross section means that the array of images of the light source will also be regular which is advantageous for ranging applications. A regular array of spots ensures that the scene is illuminated in a known manner and will ease discrimination of spots for ranging purposes. A square section tube is most preferred.

The tube may comprise a hollow tube having reflective internal surfaces, i.e. mirrored internal walls. Alternatively the tube may be fabricated from a solid material and arranged such that a substantial amount of light incident at an interface between the material of the tube and surrounding material undergoes total internal reflection. The tube material may be either coated in a coating with a suitable refractive index or designed to operate in air, in which case the refractive index of the light guide material should be such that total internal reflection occurs at the material air interface.

Using a tube like this as a light guide results in multiple images of the light source being generated which can be projected to the scene across a wide angle. The light guide is easy to manufacture and assemble and couples the majority of the light from the source to the scene. Thus low power sources such as light emitting diodes can be used. As the exit aperture of the light guide is generally small the apparatus also has a large depth of field which, as mentioned, makes it useful for ranging applications which require spots projected that are separated over a wide range of distances. Typically, the light guide has a cross sectional area in the range of a few square millimetres to a few tens of square millimetres, for instance the cross sectional area may be in the range of 1-50 mm² or 2-25 mm². As mentioned the light guide preferably has a regular shape cross section with a longest dimension of a few millimetres, say 1-5 mm. One embodiment as mentioned is a square section tube having a side length of 2-3 mm. The light guide may have a length of a few tens of millimetres, a light guide may be between 10 and 70 mm long. Such light guides can generate a grid of spots over an angle of 50-100 degrees (typically about twice the total internal angle within the light guide). Depth of field is generally found to be large enough to allow operation from 150 mm out to infinity. Other arrangements of light guide may be suitable for certain applications however.

The projection optics may comprise a projection lens. The projection lens may be located adjacent the output face of the light guide. In some embodiments where the light guide is solid the lens may be integral to the light guide, i.e. the tube may be shaped at the output face to form a lens.

All beams of light projected by the apparatus according to the present invention pass through the end of the light guide and can be thought of as originating from the point at the centre of the end face of the light guide. The projection optics can then comprise a hemispherical lens and if the centre of the hemisphere coincides with the centre of the light guide output face the apparent origin of the beams remains at the same point, i.e. each projected image has a common projection origin. In this arrangement the projector does not have an axis as such as it can be thought of a source of beams radiating across a wide angle which is very useful for ranging applications. Other projection optics could be used however for different effects.

Preferably the projection optics are adapted so as to sharply focus the projected array at a relatively large distance. This provides a sharper image at that distance and a blurred image at closer distances. The amount of blurring can give some coarse range information which can be useful for ranging applications. The discrimination is improved if the light source has a non circular shape.

For ranging applications it is necessary for the range detector to be able to detect a spot in the scene and know unambiguously what spot in the projected array it corresponds to. Providing coarse range information in the focussing can help remove some ambiguity. Therefore the projection optics are preferably adapted to provide a substantially focussed image at a first distance and a substantially unfocussed image at a second distance, the first and second distance being within the expected range of operation of the apparatus. As mentioned the first distance may be larger than the second distance.

In order to further remove ambiguity the light source may have a shape which is not symmetric about the axes of reflection of the light guide. If the light source is not symmetrical about the axis of reflection the light source will be different to its mirror image. Adjacent spots in the projected array are mirror images and so shaping the light source in this manner would allow discrimination between adjacent spots.

The apparatus may comprise more than one light source, each light source arranged to illuminate part of the input face of the light guide. Using more than one light source can improve the spot resolution in the scene. Preferably the plurality of light sources are arranged in a regular pattern. The light sources may be arranged such that different arrangements of sources can be used to provide differing spot densities. For instance a single source could be located in the centre of the input face of the light guide to provide a certain spot density. A separate two by two array of sources could also be arranged on the input face and could be used instead of the central source to provide an increased spot density.

Where a plurality of light sources are used, at least one light source could be arranged to emit light at a different wavelength to another light source. Using sources with different wavelengths means that the array of spots projected into a scene will have differing wavelengths, in effect the sources and hence corresponding spots will be different colours—although the skilled person will appreciate that the term colour is not meant to imply operation in the visible spectrum. Having varying colours will help remove ambiguity over which spot is which in the projected array.

Alternatively at least one light source could be shaped differently from another light source, preferably at least one light source having a shape that is not symmetric about a reflection axis of the light guide. Shaping the light sources again helps discriminate between spots in the array and having the shapes non symmetrical means that mirror images will be different, further improving discrimination as described above.

At least one light source could be located within the light guide, at a different depth to another light source. The angular separation of the projected array of beams emanating from a kaleidoscope is determined by the ratio of its length to its width as will be described later. Locating at least one light source within the kaleidoscope shortens the effective length of light guide for that light source. Therefore the resulting pattern projected towards the scene will comprise more than one array of spots having different periods. The degree of overlap of the spot will therefore change with distance from the centre of the array which can be used to identify each spot uniquely.

The light source may be arranged to run from one side of the input face to another such that the structured light generator illuminates the scene with an array of lines. If a light source is used which is arranged to run from one side of the input face of the light guide to another in a direction orthogonal to a reflection axis the effect will be that a constant line is projected onto the scene which can be useful for some applications. In some embodiments it may be wished to illuminate the scene with intersecting lines. The points of intersection between the lines may be used for identification for ranging purposes in a similar manner to separated spots as described above and for the purposes of this specification any reference to a spot should be taken to include an identifiable point of illuminated light such as the intersection point between continuous lines. The points of intersection therefore can be used to locate the range to that point. That range information could then be used to allow ranging to any other point on the line, i.e. a point on the line which is not a point of intersection, allowing more detailed range information to be gathered. In some cases however is may be best to range to separate spots and then activate the lines in which case the light source may be adapted to illuminate the light guide so as to produce an array of lines or an array of separate spots.

In another embodiment one or more light sources may be arranged so as to illuminate the input face of the light guide through a mask. The mask may be arranged so that the light source only illuminates a part or parts of the input face, i.e. the mask may have at least one transmissive portion and the or each transmissive portion may be arranged to illuminate only part of the input face of the light guide. Therefore rather than use a relatively small light source arranged to illuminate only part of the input face of the light guide one or more light sources could be used to illuminate a mask. The mask would only allow light through to part of the input face of the light guide and so a larger light source or collection of sources could be used. The mask may have more than one transmissive portion so that a single light source could illuminate separate parts of the input face of the light guide. Therefore several distinct spots of light could be generated on the input face of the light guide using only one source or possibly a small array of sources.

Using a mask in this fashion requires the mask to be accurately located at the input face of the light guide. This is easier than requiring accurate location of a light source or light source array, and may be achieved by printing or otherwise processing the end of the kaleidoscope. The positioning of the light source or sources is then less critical as it is only necessary for them to be arranged to illuminate the mask.

The transmissive portion or portions of the mask may have a distinct non-circular shape. As mentioned above, projecting a spot with a distinct non-circular shape can help give range information if it is sharply focussed at one range and unfocussed at another. Similarly if the mask has several transmissive portions to illuminate several different areas of the input face of the light guide at least some could have different shapes to aid spot identification in a ranging system. Shaping the transmissive portions of an input mask is generally easier than providing shaped light sources. Additionally or alternatively the mask may comprise different transmissive portions at least some of which are transmissive at different wavelengths. In other words the mask may have a plurality of windows each operating as a different colour filter. When the mask is illuminated with a white light source different parts of the input face will be illuminated with different colour spots which will be replicated and projected towards the scene. Of course the invention is not limited to visible wavelengths and the term colour should be construed accordingly. The mask may also have a transmissive portion arranged to run from one side of the input face of the light guide to another so as to allow the light source to illuminate the input face of the light guide with at least one line. This will result in the structured light generator projecting an array on lines onto the scene. In some embodiments the mask may be arranged such that an array of intersecting lines is projected with the same advantages as described above with respect to a continuous light source.

The mask may comprise a modulator, such as an electro-optic modulator. Using a modulator to form at least part of the mask could allow control of the transmission characteristics of certain portions of the mask which in turn controls the illumination to the input face of the light guide. For instance certain windows or transmissive portions could be switched from transmissive to non-transmissive to turn certain spots in the array off and vice versa. Accordingly the term transmissive portion should not be read as being limited to a portion which is always transmissive, merely one that is capable of being transmissive at at least one wavelength of operation. As an alternative the wavelength of transmission of a window in the mask could be changed so that the colour of certain spots in the array may be changed. As mentioned above when used in ranging applications it may be necessary to alter the characteristics of some spots in the array so as to permit unique identification of the spots observed in the scene to resolve any range ambiguities.

To ensure uniform illumination of the mask, a homogeniser is preferably provided between the light source or sources and the mask. The homogeniser may comprise a simple light pipe such as a plastic light pipe for providing uniform illumination.

The non transmissive parts of the mask may be reflective so that light which is not transmitted may be reflected back from the mask to be used again. Re-circulating the non-transmitted light in this way helps reduce the brightness of light source or sources needed reducing the power requirements

The structured light generator may conveniently comprise a controllable means of redirecting the direction of the projected radiation. In some applications it may be desired to redirect the projected array of light. For instance higher resolution range information could be acquired by redirecting the projected array between captured frames so as to project the spots onto different parts of the scene allowing more range points to be calculated. Conveniently the means of redirecting the radiation comprises a refractive element which may rotated so as to redirect the projected array to a different part of the scene. For instance the redirection means may comprise refractive wedge which is mounted for rotation about an axis and is adapted to refract radiation away from that axis.

As mentioned the present invention is particularly suitable for illuminating a scene with structured light so that an imaging based ranging system can determine the range to points in the image. The invention also relates to means by which the structured light can be projected to a scene allowing for the unique identification of an observed point in the projected array with a projected beam removing any possible range ambiguity.

The invention will now be described by way of example only with reference to the following drawings of which;

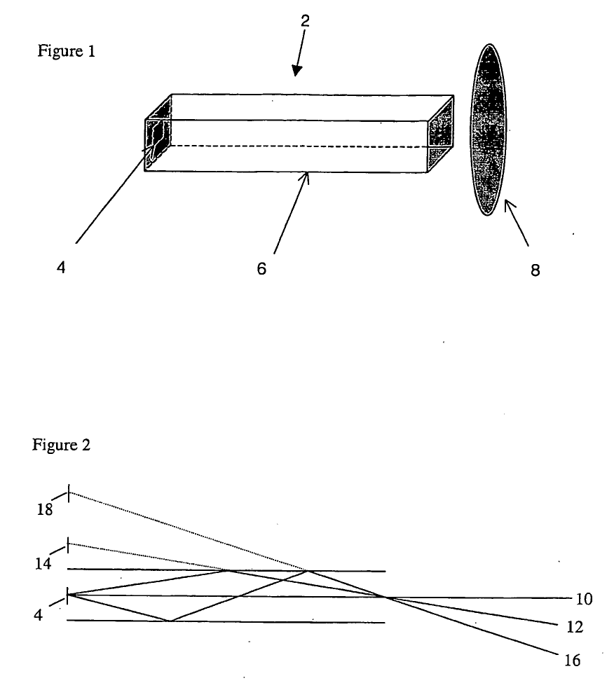

FIG. 1 shows a structured light source according to the present invention,

FIG. 2 illustrates how the structured light source projects multiple spots,

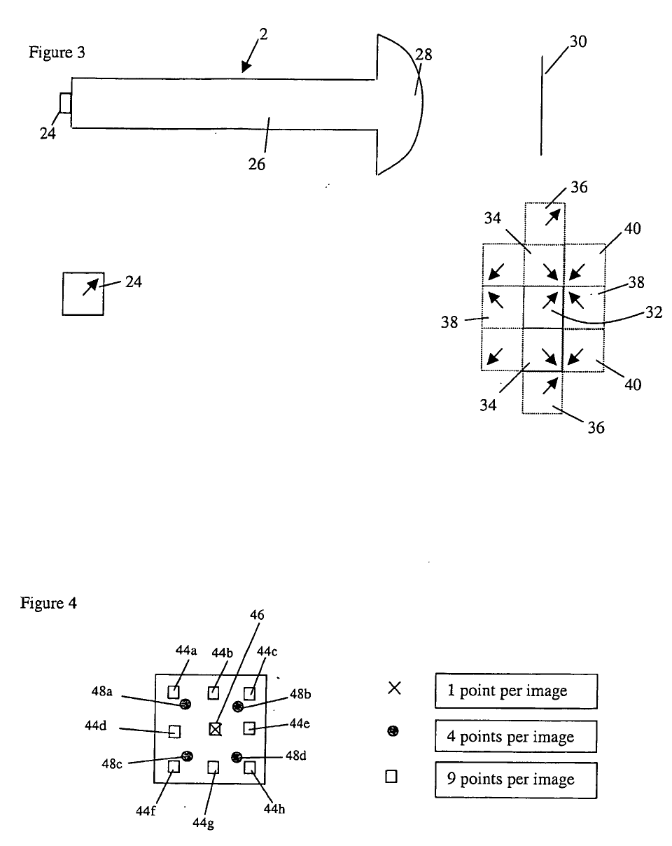

FIG. 3 shows another embodiment of a structured light generator according to the present invention,

FIG. 4 shows the input face of a light guide of the present invention having a plurality of light sources,

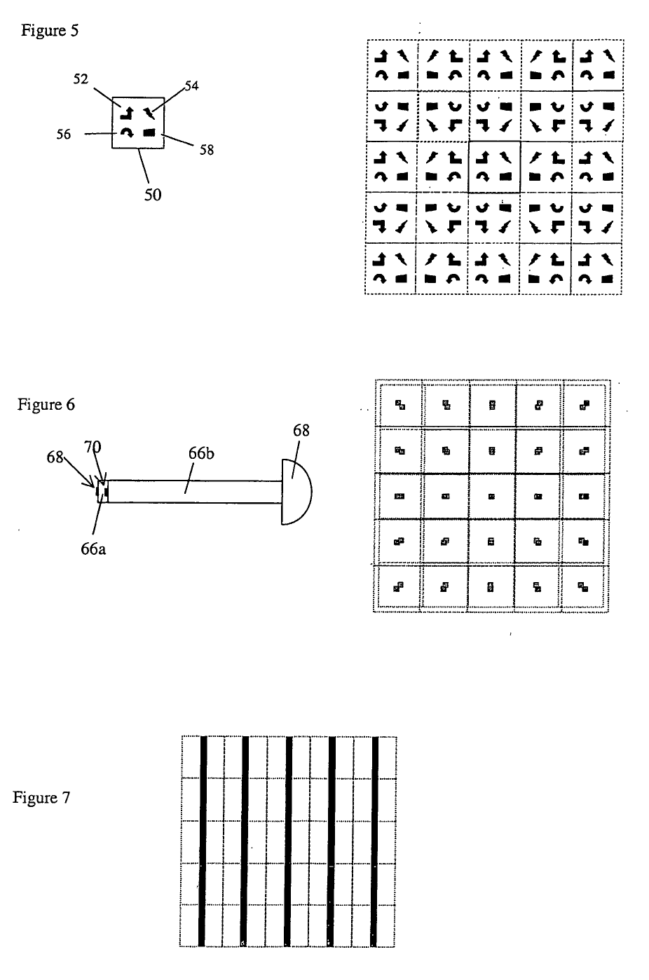

FIG. 5 shows the input face of a light guide of the present invention having a plurality of shaped light sources and part of the pattern projected toward the scene,

FIG. 6 shows a structured light source having two light sources arranged at different depths and a part of the pattern projected towards the scene,

FIG. 7 shows the output pattern of a structured light source arranged to illuminate the scene with a plurality of lines,

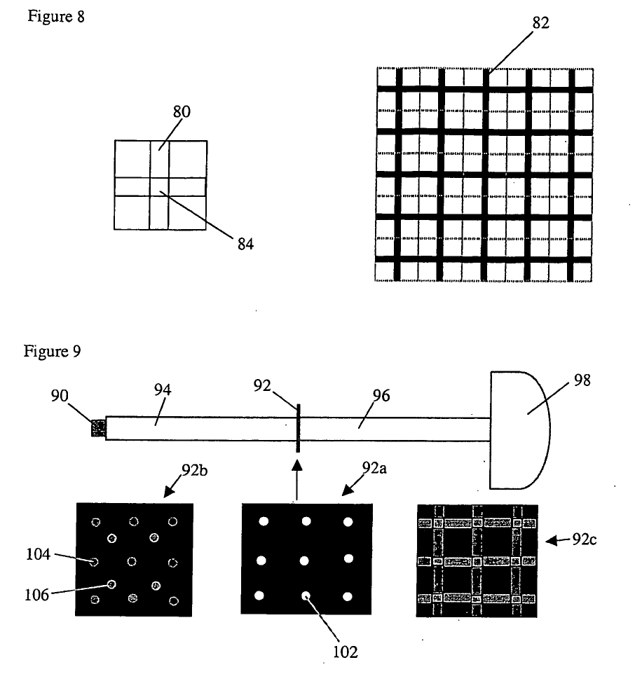

FIG. 8 illustrates the input face and output pattern of a structured light source arranged to illuminate the scene with an array of intersecting lines, and

FIG. 9 shows a structured light source according to another aspect of the invention.

A structured light source generally indicated 2 according to the present invention is shown in FIG. 1. A light source 4 is located adjacent an input face of a kaleidoscope 6. At the other end is located a simple projection lens 8. The projection lens is shown spaced from the kaleidoscope for the purposes of clarity but would generally be located adjacent the output face of the kaleidoscope.

The light source 4 is an infrared emitting light emitting diode (LED). Infrared is useful for ranging applications as the array of projected spots need not interfere with a visual image being acquired and infrared LEDs and detectors are reasonably inexpensive. However the skilled person would appreciate that other wavelengths and other light sources could be used for other applications without departing from the spirit of the invention.

The kaleidoscope is a hollow tube with internally reflective walls. The kaleidoscope could be made from any material with suitable rigidity and the internal walls coated with suitable dielectric coatings. However the skilled person would appreciate that the kaleidoscope could comprise a solid bar. Any material which is transparent at the wavelength of operation of the LED would suffice, such as clear optical glass. The material would need to be arranged such that at the interface between the kaleidoscope and the surrounding air the light is totally internally reflected within the kaleidoscope. This may be achieved using additional (silvering) coatings, particularly in regions that may be cemented with potentially index matching cements/epoxies etc. Where high projection angles are required this could require the kaleidoscope material to be cladded in a reflective material. An ideal kaleidoscope would have perfectly rectilinear walls with 100% reflectivity. It should be noted that a hollow kaleidoscope may not have an input or output face as such but the entrance and exit to the hollow kaleidoscope should be regarded as the face for the purposes of this specification.

The effect of the kaleidoscope tube is such that multiple images of the LED can be seen at the output end of the kaleidoscope. The principle is illustrated with reference to FIG. 2. Light from the LED 4 may be transmitted directly along the kaleidoscope undergoing no reflection at all—path 10. Some light however will be reflected once and will follow path 12. Viewed from the end of the kaleidoscope this will result in a virtual source 14 being seen. Light undergoing two reflections would travel along path 16 resulting in another virtual source 18 being observed.

The dimensions of the device are tailored for the intended application. Imagine that the LED 4 emits light into a cone with a full angle of 90°. The number of spots viewed on either side of the central, unreflected, spot will be equal to the kaleidoscope length divided by its width. The ratio of spot separation to spot size is determined by the ratio of kaleidoscope width to LED size. Thus a 200 μm wide LED and a kaleidoscope 30 mm long by 1 mm square will produce a square grid of 61 spots on a side separated by five times their width (when focussed). As the effective exit aperture is low at 1 mm square the device has a large depth of field making it particularly suited to ranging based applications. The above described kaleidoscope may have a depth of field from 100 mm to infinity. Other kaleidoscope dimensions will be used for other applications. A square section kaleidoscope of 2-3 mm square may be used with a length of say 20-50 mm to generate various spot densities.

Projection lens 8 is a simple singlet lens arranged at the end of kaleidoscope and is chosen so as to project the array of images of the LED 4 onto the scene. The projection geometry again can be chosen according to the application and the depth of field required but a simple geometry is to place the array of spots at or close to the focal plane of the lens. A useful feature of the projector arrangement according to the present invention is that, as shown in FIG. 2, all the beams pass through the end of the kaleidoscope and can be thought of as originating from the centre of the output face of the kaleidoscope. Projection lens 8 may therefore be a hemispherical lens and, if arranged with its axis coincident with the centre of the exit face, will preserve the apparent origin of the beams. FIG. 3 shows a hemispherical lens 28 formed integrally with the kaleidoscope 26. Thus the projector according to the present invention is advantageous in projecting images of the input face of the kaleidoscope across a wide angle and effectively has no axis to speak of, unlike prior art projection systems.

For some ranging applications it is advantageous that the spots are sharply focussed at one likely range and less focussed at another likely range. Where a structured light generator according to the present invention is used for ranging applications the scene is illuminated with a projected array of spots. A detector arranged to determine the location of spots in the scene can then work out the angle and hence range to that spot but only if it can determine exactly which spot is which. Determination of whether a spot were focussed or not would give a rough indication of range and hence remove some ambiguity about which spot was being considered. This discrimination can be improved if the LED is a particular shape, such as square so that an in-focus spot is also square. An unfocussed spot would be more circular in shape.

In one embodiment of the invention the light source is shaped so as to allow discrimination between adjacent spots. Where the light source is symmetric about the appropriate axes of reflection the spots produced by the system are effectively identical. However where a non symmetrically shaped source is used adjacent spots will be distinguishable mirror images of each other. The principle is illustrated in FIG. 3.

The structured light generator 2 comprises a solid tube of clear optical glass 26 having a square cross section. A shaped LED 24 is located at one face. The other end of tube 26 is shaped into a projection lens 28. As mentioned above kaleidoscope 26 and lens 28 are therefore integral which increases optical efficiency and eases manufacturing as a single moulding step may be used. Alternatively a separate lens could be optically cemented to the end of a solid kaleidoscope with a plane output face.

For the purposes of illustration LED 24 is shown as an arrow pointing to one corner of the kaleidoscope, top right in this illustration. The image formed on a screen 30 is shown. A central image 32 of the LED is formed corresponding to an unreflected spot and again has the arrow pointing to the top right. Note that in actual fact a simple projection lens will project an inverted image and so the images formed would actually be inverted. However the images are shown not inverted for the purposes of explanation. The images 34 above and below the central spot have been once reflected and therefore are a mirror image about the x-axis, i.e. the arrow points to the bottom right. The next images 36 above or below however have been twice reflected about the x-axis and so are identical to the centre image. Similarly the images 38 to the left and right of the centre image have been once reflected with regard to the y-axis and so the arrow appears to point to the top left. The images 40 diagonally adjacent the centre spot have been reflected once about the x-axis and once about the y-axis and so the arrow appears to point to the bottom left. Thus the orientation of the arrow in the detected image gives an indication of which spot is being detected. This technique allows discrimination between adjacent spots but not subsequent spots.

Additionally or alternatively more than one light source could be used. The light sources could be used to give variable resolution in terms of spot density in the scene, or could be used to aid discrimination between spots, or both.

For example if more than one LED were used and each LED was a different colour the pattern projected towards the scene would have different coloured spots therein. The skilled person would appreciate that the term colour as used herein does not necessarily mean different wavelengths in the visible spectrum but merely that the LEDs have distinguishable wavelengths.

The arrangement of LEDs on the input face of the kaleidoscope effects the array of spots projected and a regular arrangement is preferred. To provide a regular array the LEDs should be regularly spaced from each other and the distance from the LED to the edge of the kaleidoscope should be half the separation between LEDs.

FIG. 4 shows an arrangement of LEDs that can be used to give differing spot densities. Thirteen LEDs are arranged on the input face 42 of a square section kaleidoscope. Nine of the LEDs, 46 & 44a-h, are arranged in a regular 3×3 square grid pattern with the middle LED 46 centred in the middle of the input face. The remaining four LEDs, 48a-d are arranged as they would be to give a regular 2×2 grid. The structured light generator can then be operated in three different modes. Either the central LED 46 could be operated on its own, this would project a regular array of spots as described above, or multiple LEDs could be operated. For instance, the four LEDs 48a-d arranged in the 2×2 arrangement could be illuminated to give an array with four times as many spots produced than with the centre LED 46 alone.

The different LED arrangements could be used at different ranges. When used to illuminate scenes where the targets are at close range the single LED may generate a sufficient number of spots for discrimination. At intermediate or longer ranges however the spot density may drop below an acceptable level, in which case either the 2×2 or 3×3 array could be used to increase the spot density. As mentioned the LEDs could be different colours to improve discrimination between different spots.

Where multiple sources are used appropriate choice of shape or colour of the sources can give further discrimination. This is illustrated with respect to FIG. 5. Here a 2×2 array of differently shaped sources, 52, 54, 56, 58 is illustrated along with a portion of the pattern produced. One can think of the resultant pattern formed as a tiled array of images of the input face 50 of the kaleidoscope with each adjacent tile being a mirror image of its neighbour about the appropriate axis. Looking just in the x-axis then the array will be built up by spots corresponding to LEDs 52 and 54 and followed by spots corresponding to their mirror images. The resultant pattern means that each spot is different from its next three nearest neighbours in each direction and ambiguity over which spot is being observed by a detector would be reduced.

Where multiple sources are used the sources may be arranged to be switched on and off independently to further aid in discrimination. For instance several LEDs could be used, arranged as described above, with each LED being activated in turn. Alternatively the array could generally operate with all LEDs illuminated but in response to a control signal from a detector which suggests some ambiguity could be used to activate or deactivate some LEDs accordingly.

In a further embodiment lights sources are arranged at different depths within the kaleidoscope. The angular separation of adjacent beams from the kaleidoscope depends upon the ratio between the length and width of the kaleidoscope as discussed above. FIG. 6 shows a square section kaleidoscope 66 and projection lens 68. The kaleidoscope tube 66 is formed from two pieces of material 66a and 66b which may be clear optical glass or any other suitable material. A first LED 68 is located at the input face of the kaleidoscope as discussed above. A second LED 70 is located at a different depth within the kaleidoscope, between the two sections 66a and 66b of the kaleidoscope. The skilled person would be well aware of how to join the two sections 66a and 66b of kaleidoscope to ensure maximum efficiency and located the second LED 70 between the two sections.

The resulting pattern contains two grids with different periods with the grid corresponding to the second LED 70 partially obscuring the grid corresponding to the first LED 68. As can be seen the degree of separation between the two spots varies with distance from the centre spot. The degree of separation or offset of the two grids could then be used to identify the spots uniquely. The LEDs 68, 70 could be different colours as described above to improve discrimination.

Up until now the invention has been described with reference to producing discrete spots. The invention could be used to project continuous lines onto the scene however. A light source comprising a strip running from one side of the input face to the other and located centrally would produce an array of continuous lines as shown in FIG. 7. Similarly a square grid could be produced by use of a cross-shaped light source as shown in FIG. 8.

Referring to FIG. 8 a cross shaped LED 80 is arranged on the input face of the kaleidoscope. This result in the pattern of intersecting lines 82 shown being projected towards the scene. The points of intersection of the lines in the output pattern can be seen as separately identifiable spots. A detector could detect a point of intersection in the same way as it could detect a distinct spot as described above. However a detector having located the range to a point of intersection could then also determine range information to any other point along the intersecting line. Therefore in some applications projecting a grid of intersecting lines can be advantageous in that the resolution of the ranging apparatus could be increased. Identification of a point of intersection may be less easy than identification of a unique spot however. In which case the cross shaped LED could comprise a separate central portion 84 which is independently operable. Activation of just the central portion 84 would result in an array of distinct spots being produced as described with reference to FIGS. 1 and 2. Once the range to each spot had been determined the rest of LED 80 could be activated to provide additional detail for ranging.

FIG. 9 shows an additional embodiment of the invention wherein instead of locating the LEDs on the input face of the light guide a mask is arranged on the input face. The structured light generator has a square section kaleidoscope 96 and projection lens 98 such as described with reference to FIG. 6 above although an integral arrangement such as shown in FIG. 3 could be used as well. A mask 92 is arranged at the input face to the kaleidoscope 96 which is illuminated by LED 90 through light pipe 94. The LED 90, which may instead be replaced by an array of LEDs or other light sources, illuminates the light pipe 94 with a relatively broad wavelength range, i.e. it may be a white light source. The light pipe 94 acts as a homogeniser and ensures that the mask 92 receives uniform illumination. The mask 92 is provided with a plurality of transmissive portions so that only a part of the input face of the kaleidoscope is illuminated. The transmissive portions of the mask 92 therefore illuminate the input face of the light guide in a similar manner to the individual LEDs of the embodiments described with reference to FIGS. 1 to 8 and all of the above mentioned advantages are therefore applicable to this embodiment of the invention.

The mask 92 may have different arrangements of transmissive windows according to the application for which the structured light generator is being used. For instance in the simplest form (not shown) the mask may comprise simply a central aperture allowing a spot to be formed at the central of the input face of the kaleidoscope effectively reproducing the system shown in FIG. 1. An alternative mask shown as 92a could have a greater density of regularly spaced apertures 102 allowing for higher spot densities. Using a mask such as mask 92a allows a high density of spots to be input to the kaleidoscope but without requiring use of very small LEDs. The manufacture of mask 92a is relatively easy and accurate alignment of mask 92 is easier than alignment of an array of LEDs. LED 90 does not need so accurate alignment as the mask (or were it located at the input face of the kaleidoscope without a mask). It is sufficient that it illuminates light pipe 94 and light pipe 94 uniformly illuminates the mask 92. Therefore manufacture of the embodiment of the invention having a mask may be easier than the embodiments without.

An alternative mask 92b is shown where different portions are formed which are transmissive at different colours. For instance windows 104 may transmit light of one wavelength, say red, whilst windows 106 may transmit light of a different wavelength, say green (although the invention is applicable to wavelengths outside the visible spectrum). This would produce an array of differently coloured spots which could aid spot identification as described above. The different windows 104, 106 could be made by using different filter materials as would be readily understood by one skilled in the art. Further single LED 90 could be replaced by two LEDs operating at different wavelengths, say a red LED and green LED such that each of the two different windows 104, 106 transmits radiation emitted by one LED only. Therefore with both LEDs activated a high density array of different coloured spots is projected. However were just one LED activated, say the red LED, only one set of windows would be transmissive, windows 104, and only a limited array of spots would be projected. This could be extended to a greater number of wavelengths.

Mask 92c shows a mask allowing a plurality of intersecting lines to be projected on to the input face of the kaleidoscope. This would produce a pattern similar to that shown in FIG. 8.

Mask 92 could be a fixed mask or the mask could comprise an electro-optical modulator such as a shutter. Individual windows in the mask could then be switched from being transmissive to non-transmissive so as to deactivate certain spots in the scene.

The light pipe 94 serves simply to guide light from the LED 90 to the mask 92 and as such can be a relatively cheap and low accuracy component, reducing system costs. The non transmissive portions of the input face of mask 92, i.e. the face receiving the light from the light pipe 94, are reflective such that non-transmitted light is reflected back into the light pipe 94 where it will reflect from the LED end of the light pipe and then be re-incident on the mask 92. As the spot diameter to spacing ratio is typically about 4:1 the transmissive portion of the mask is only around one sixteenth of its area. Re-circulating the non-transmitted light increases the efficiency of the device reducing the power requirement for the LEDs.

1. A structured light generator for illuminating a scene comprising a light source arranged to illuminate part of the input face of a light guide, the light guide comprising a tube having substantially reflective sides and being arranged together with projection optics so as to project an array of distinct images of the light source towards the scene.

2. A structured light generator as claimed in claim 1 wherein the light guide comprises a tube having a constant cross section.

3. A structured light generator as claimed in claim 2 wherein the cross section of the tube is a regular polygon.

4. A structured light generator as claimed in claim 3 wherein the tube has a square cross section.

5. A structured light generator as claimed in claim 1 wherein the cross sectional area of the light guide is in the range 1 to 50 mm² or 2 to 25 mm².

6. A structured light generator as claimed in claim 1 wherein the light guide comprises a hollow tube having reflective internal surfaces.

7. A structured light generator as claimed in claim 1 wherein the light guide comprises a tube of solid material adapted such that a substantial amount of light incident at an interface between the material of the tube and surrounding material undergoes total internal reflection.

8. A structured light generator as claimed in claim 1 wherein the light guide is between 10 and 70 mm long.

9. A structured light generator as claimed in claim 1 wherein the projection optics comprises a projection lens.

10. A structured light generator as claimed in claim 7 wherein the tube of solid material is shaped at the output face to form the projection lens.

11. A structured light generator as claimed in claim 9 wherein the projection lens is a hemispherical lens.

12. A structured light generator as claimed in claim 11 wherein the centre of the hemispherical lens is located at the centre of the output face of the light guide.

13. A structured light generator as claimed in claim 1 wherein the array of images projected towards the scene have a common point of origin.

14. A structured light generator as claimed in claim 1 wherein the projection optics are preferably adapted to provide a substantially focussed image at a first distance and a substantially unfocussed image at a second distance, the first and second distance being within the expected range of operation of the apparatus.

15. A structured light generator as claimed in claim 14 wherein the first distance may be larger than the second distance.

16. A structured light generator as claimed in claim 1 wherein the light source has a non-circular shape.

17. A structured light generator as claimed in claim 16 wherein the light source has a shape which is not symmetric about the axes of reflection of the light guide.

18. A structured light generator as claimed in claim 1 comprising more than one light source, each light source arranged to illuminate part of the input face of the light guide.

19. A structured light generator as claimed in claim 18 wherein the light sources are arranged in a regular pattern.

20. A structured light generator as claimed in claim 18 wherein the light sources are arranged such that different arrangements of sources can be used to provide differing spot densities.

21. A structured light generator as claimed in claim 18 wherein at least one light source emits light at a different wavelength to another light source.

22. A structured light generator as claimed in claim 18 wherein at least one light source is shaped differently from another light source.

23. A structured light generator as claimed in claim 18 wherein at least one light source has a shape that is not symmetric about a reflection axis of the light guide.

24. A structured light generator as claimed in claim 18 wherein at least one light source is located within the light guide, at a different depth to another light source.

25. A structured light generator as claimed in claim 1 wherein the light source is arranged to run from one side of the input face to another such that the structured light generator illuminates the scene with an array of lines.

26. A structured light generator as claimed in claim 25 wherein the light source is arranged relative to the light guide so as to illuminate the scene with intersecting lines.

27. A structured light generator as claimed in claim 25 wherein the light source may is adapted so as to be capable of illuminate the light guide so as to produce either an array of lines or an array of separate spots.

28. A structured light generator as claimed in claim 1 wherein the light source is arranged to illuminate the input face of the light guide through a mask.

29. A structured light generator as claimed in claim 28 wherein the mask has at least one transmissive portion, the or each transmissive portion being arranged to illuminate only part of the input face of the light guide.

30. A structured light generator as claimed in claim 29 wherein the or at least one of transmissive portions of the mask has a non-circular shape.

31. A structured light generator as claimed in claim 30 wherein the mask has a plurality of transmissive portions and at least some of the transmissive portions have different shapes.

32. A structured light generator as claimed in claim 28 wherein the mask has a plurality of transmissive portions and at least some transmissive portions are transmissive at different wavelengths.

33. A structured light generator as claimed in claim 28 wherein has at least one transmissive portion arranged to run from one side of the input face of the light guide to another such that the structured light generator illuminates the scene with an array of lines.

34. A structured light generator as claimed in claim 28 wherein the mask comprises a modulator adapted such that the transmission characteristics of at least part of the mask may be varied.

35. A structured light generator as claimed in claim 28 further comprising a homogeniser disposed between the light source and the mask.

36. A structured light generator as claimed in claim 1 wherein the generator projects an array of images over an angle of between 50° to 100°.

37. A structured light generator as claimed in claim 1 wherein the generator has a depth of field of 100 mm to infinity.
